(19) United States
(12) Patent Application Publication
(10) Pub. No.: US 2023/0160378 A1
(43) Pub. Date: May 25, 2023

(54) WATER FLOSSER PUMP BODY STRUCTURE AND WATER FLOSSER

(71) Applicant: NINGBO SEAGO ELECTRIC CO., LTD., NINGBO (CN)

(72) Inventors: Yanzhong Cai, NINGBO (CN); Weibing Peng, NINGBO (CN)

(73) Assignee: NINGBO SEAGO ELECTRIC CO., LTD., NINGBO (CN)

(21) Appl. No.: 18/100,692

(22) Filed: Jan. 24, 2023

(30) Foreign Application Priority Data
Oct. 15, 2022 (CN) 202211262852.9
Oct. 31, 2022 (CN) 202222872907.X

(51) Int. Cl. F04B 43/02; A61C 17/024

(52) U.S. Cl. CPC F04B 43/02; A61C 17/024

(57) ABSTRACT

The present invention pertains to a water flosser pump body structure and a water flosser, the water flosser pump body structure comprises a housing, a water pump assembly, a transmission assembly and a driving assembly, the water pump assembly comprises a pump body, an inlet valve member, an outlet valve member and an elastic diaphragm, the pump body has a water flow cavity therein, the inlet valve sheet and the water flow cavity form an inlet channel, and the outlet valve sheet and the water flow cavity form an outlet channel; and the transmission assembly rotates to drive the elastic diaphragm to repeatedly deform so as to cause a change in pressure in the water flow cavity, thereby realizing a pumping and jetting process of the water flosser for flossing teeth.

### TECHNICAL FIELD

The present invention belongs to the technical field of water flosser equipment, and specifically pertains to a water pump body structure for a water flosser and a water flosser.

### BACKGROUND

A water flosser is an oral cleaning device, and its principle is to use flowing pulsating water to remove dental plaque and food residue in gingival crevices, thereby improving oral health. However, a pump structure for the water flosser is a core component of the water flosser. An existing diaphragm pump for the water flosser has the defects that a water flow cavity is large in volume, liquid cannot be completely discharged in pumping and jetting operations in a single process, so that air is accumulated in a cavity of a pump body in a reciprocating motion process, water inflow of the pump body is insufficient due to insufficient air pressure in the cavity of the pump body, water yield of the pump body is insufficient, and normal use of the water flosser is affected.

### SUMMARY

To overcome the deficiencies of the prior art, the present invention provides a water flosser pump body structure and a water flosser.

The water flosser pump body structure comprises a housing, a water pump assembly, a transmission assembly, and a driving assembly. The water pump assembly comprises a pump body, an inlet valve member, an outlet valve member and an elastic diaphragm; the inlet valve member is provided with an inlet thereon, the outlet valve member is provided with an outlet thereon, the inlet valve member is further provided with an inlet valve sheet thereon, and the outlet valve member is provided with an outlet valve sheet thereon, a water flow cavity is provided inside the pump body, the inlet valve sheet and the water flow cavity form an inlet channel, and the outlet valve sheet and the water flow cavity form an outlet channel; and when the transmission assembly rotates, the elastic diaphragm can be driven to repeatedly deform to cause a change in pressure in the water flow cavity, thus realizing a pumping and jetting process of the water flosser for flossing teeth.

According to an embodiment of the present invention, the elastic diaphragm is hermetically connected with the pump body, the pump body comprises an upper pump body and a lower pump body, both ends of the pump body connected with the elastic diaphragm have a pump body end face chamfer, and the upper pump body has a first drainage channel and a second drainage channel in the direction of the outlet channel.

According to an embodiment of the present invention, the elastic diaphragm comprises a deformation portion and a connection portion, the connection portion is used for connected and fixed with the pump body, and the deformation portion comprises a first deformation portion and a second deformation portion.

According to an embodiment of the present invention, a thickness of the first deformation portion of the elastic diaphragm is greater than a thickness of the second deformation portion, a length of the second deformation portion is less than a length of the first deformation portion, and a hardness of the first deformation portion is greater than a hardness of the second deformation portion.

According to an embodiment of the present invention, the elastic diaphragm is integrally formed, and the elastic diaphragm is made of an elastic material such as rubber and silica gel.

According to an embodiment of the present invention, the transmission assembly comprises a gear transmission mechanism and a connecting rod, and the gear transmission mechanism is connected with the connecting rod for driving the connecting rod to move.

According to an embodiment of the present invention, the connecting rod is connected with the elastic diaphragm through a connector.

According to an embodiment of the present invention, the gear transmission mechanism comprises a gear and an eccentric gear, the gear is in meshing rotation with the eccentric gear, the eccentric gear further comprises an eccentric gear fixing shaft, and the eccentric gear fixing shaft is connected with the connecting rod.

According to an embodiment of the present invention, when the gear transmission mechanism pulls the elastic diaphragm from inside to outside, the deformation portion of the elastic diaphragm can be deformed towards the outside of the water flow cavity, so that a volume inside the water flow cavity increases, and external water can enter the water flow cavity from the inlet through the one-way inlet valve sheet.

According to an embodiment of the present invention, when the gear transmission mechanism pushes the elastic diaphragm from outside to inside, the elastic diaphragm can be deformed towards the inside of the water flow cavity, so that the volume inside the water flow cavity decreases, and water in the water flow cavity can be sprayed out from the outlet through the outlet valve sheet.

According to an embodiment of the present invention, the inlet has a single intake volume less than or equal to a maximum intake containment volume of the water flow cavity, and the water flow cavity is used for containing a tooth wash liquid.

According to an embodiment of the present invention, the inlet valve sheet and the outlet valve sheet are one-way valve sheets, and a flow direction of the liquid through the valve sheets is one-way.

According to an embodiment of the present invention, the driving mechanism comprises a micro-motor, and the micro-motor has a motor output shaft thereon.

According to an embodiment of the present invention, the upper pump body is connected with the inlet valve member and the outlet valve member, and a sealing ring is provided at a connection between the inlet valve member or the outlet valve member and the upper pump body.

According to an embodiment of the present invention, the inlet valve member is provided with a limiting groove thereon, and the limiting groove limits an opening and closing angle of the inlet valve sheet.

According to an embodiment of the present invention, a water flosser comprises the water flosser pump body structure described above.

The water flosser pump body structure and the water flosser according to the present invention replace piston motion of a conventional piston with reciprocating motion of the elastic diaphragm to reduce energy loss due to friction. In addition, the volume of the water flow cavity in the pump body is small, and a distance from the inlet to the water flow cavity is short; a drainage channel is provided in the water pump assembly; in pumping and jetting operations in a single process, the liquid in the water flow cavity can be completely discharged, which decreases reaction force of the water pressure on the elastic diaphragm in the reciprocating motion of the water pump assembly, solves abnormal water inflow and outflow of the pump body due to accumulated air in the cavity of the water pump assembly which cannot be removed under natural water inflow and outflow state of a conventional diaphragm pump, and improves flossing efficiency.

### BRIEF DESCRIPTION OF THE DRAWINGS

FIG. 1 is a structural diagram of a water flosser pump body structure and a water flosser according to the present invention;

FIG. 2 is an exploded view of the water flosser pump body structure and the water flosser according to the present invention;

FIG. 3 is a cross-sectional view of the water flosser pump body structure and the water flosser according to the present invention;

FIG. 4 is an enlarged diagram of the water flosser pump body structure and a pump body structure of the water flosser according to the present invention;

FIG. 5 is a structural diagram of an elastic diaphragm of the water flosser pump body structure and the water flosser according to the present invention;

FIG. 6 is a cross-sectional view of the water flosser pump body structure and the water flosser of the present invention in a pumping state;

FIG. 7 is a schematic diagram of liquid flow of the water flosser pump body structure and the water flosser of the present invention in the liquid pumping state;

FIG. 8 is a cross-sectional view of the water flosser pump body structure and the water flosser of the present invention in a jetting state;

FIG. 9 is a schematic diagram of liquid flow of the water flosser pump body structure and the water flosser of the present invention in the jetting state;

FIG. 10 is an enlarged diagram of an inlet valve member of the water flosser pump body structure and the water flosser according to the present invention;

FIG. 11 is a cross-sectional view of another embodiment of the water flosser pump body structure and the water flosser according to the present invention;

FIG. 12 is a cross-sectional view of the water flosser pump body structure and the water flosser shown in the embodiment of FIG. 11 in the jetting state.

1-housing, 11-upper housing, 12-lower housing;
2-water pump assembly, 20-pump body, 201-pump body end face chamfer, 21-upper pump body, 211-first drainage channel, 212-second drainage channel, 22-lower pump body, 23-inlet valve member, 231-inlet, 232-inlet valve sheet, 233-limiting groove, 24-outlet valve member, 241-outlet, 242-outlet valve sheet, 25-elastic diaphragm, 251-deformation portion, 2511-first deformation portion, 2512-second deformation portion, 252-connecting portion, 26-water flow cavity, 261-inlet channel, 262-outlet channel, 27-sealing ring, 28-connector;
3-transmission assembly, 31-gear transmission mechanism, 311-gear, 312-eccentric gear, 3121-eccentric gear fixing shaft, 32-connecting rod, 321-first fixing portion, 322-second fixing portion;
4-driving assembly, 41-micro-motor, 42-motor output shaft.

### DESCRIPTION OF THE EMBODIMENTS

Exemplary embodiments of the present invention are described below with reference to the accompanying drawings. It should be understood that the detailed description is intended only to teach those skilled in the art how to practice the present invention, and is not intended to be exhaustive or to limit the scope of the present invention.

The serial numbers themselves, such as “first”, “second” and the like, are used herein only to distinguish the objects described, and do not have any sequential or technical meaning. As used herein, the terms “connected” and “coupled” are intended to include both direct and indirect connection (coupling), unless otherwise specified.

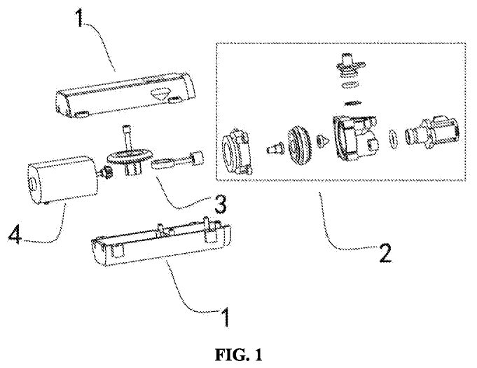

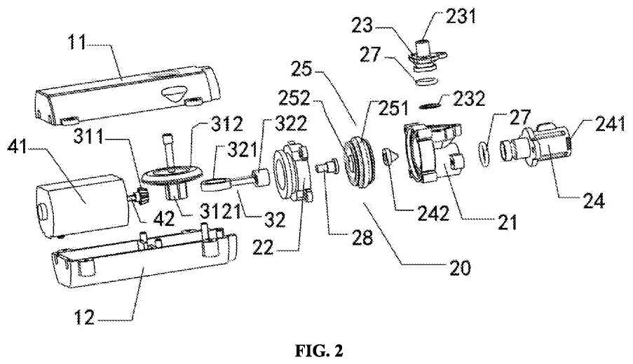

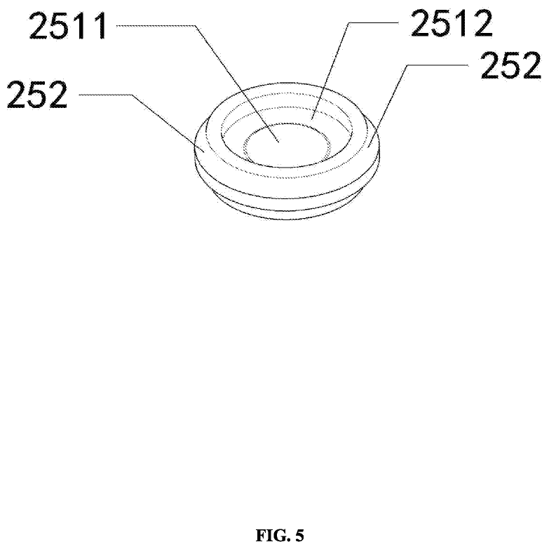

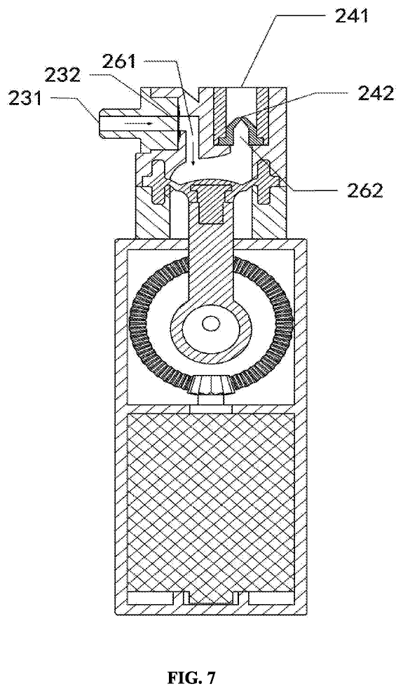

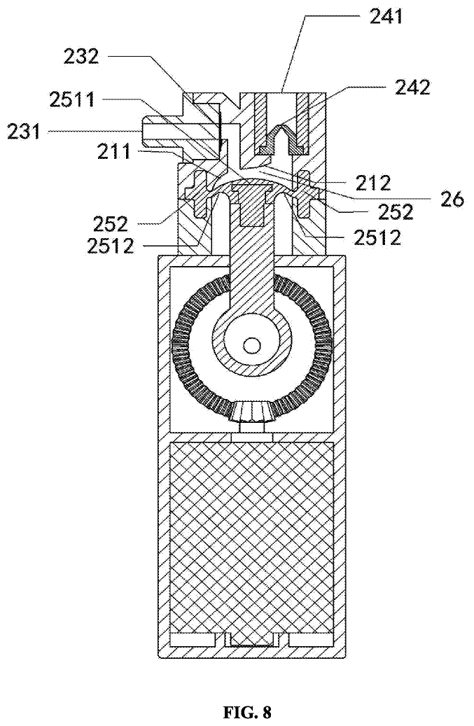

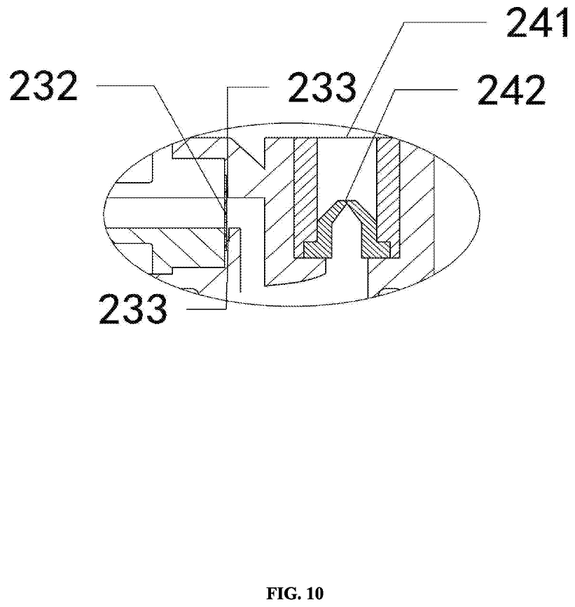

Referring to FIGS. 1-11, the present invention provides a water flosser pump body for mounting to a water flosser (not shown).

Referring to FIGS. 1-11, the present invention provides a water flosser pump body structure, comprising a housing 1, a water pump assembly 2, a transmission assembly 3, and a driving assembly 4. The driving assembly 4 is used for driving the transmission assembly 3, and the transmission assembly 3 provides power to the water pump assembly 2 through reciprocating motion, thereby achieving water intake and jetting effect of the water pump assembly 2. The housing 1 comprises an upper housing 11 and a lower housing 12, the housing has a mounting cavity therein, and the transmission assembly 3 and the driving assembly 4 are mounted in the mounting cavity.

The water pump assembly 2 comprises a pump body 20, the pump body 20 comprises an upper pump body 21 and a lower pump body 22, and the water pump assembly 2 further comprises an inlet valve member 23, an outlet valve member 24 and an elastic diaphragm 25. The inlet valve member 23 is provided with an inlet 231 thereon, and the outlet valve member 24 is provided with an outlet 241 thereon. The inlet valve member 23 is further provided with an inlet valve sheet 232 thereon, the outlet valve member 24 is provided with an outlet valve sheet 242 thereon, and the pump body 20 has a water flow cavity 26 therein, and the water flow cavity 26 is used for containing tooth wash liquid. The upper pump body 21 is connected with the inlet valve member 23 and the outlet valve member 24, and the upper pump body 21 and/or the lower pump body 22 is used for being fixedly connected to the elastic diaphragm 25.

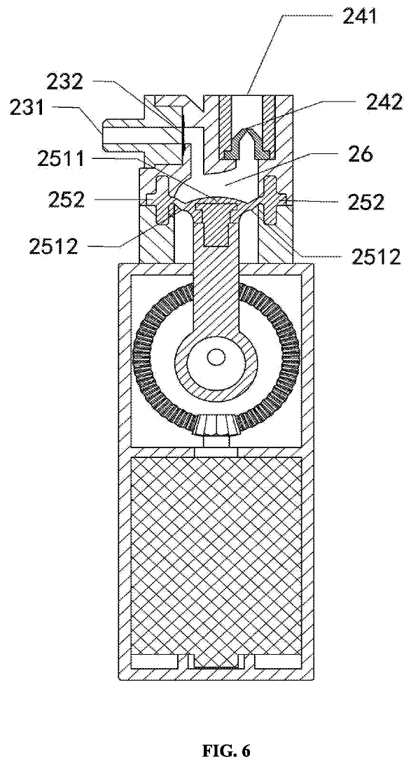

Referring to FIGS. 6-9, the inlet valve sheet 232 and the water flow cavity 26 form an inlet channel 261, and the outlet valve sheet 242 and the water flow cavity 26 form an outlet channel 262. When the water pump assembly 2 performs pumping operation, the outlet valve sheet 242 is closed, the elastic diaphragm 25 contracts downwards and deforms, a volume in the water flow cavity 26 increases, pressure in the water flow cavity 26 decreases, liquid flows in from the inlet 231 and impacts the inlet valve sheet 232 to open the same, and the liquid flows into the inlet channel 261 and then reaches the water flow cavity 26. When the water pump assembly 2 performs jetting operation, the inlet valve sheet 232 is closed, the elastic diaphragm 25 is ejected upwards and deformed, the volume in the water flow cavity 26 decreases, the liquid flows into the outlet channel 262 and impacts the outlet valve sheet 242 to open the same, and the liquid is jetted out from the outlet 241.

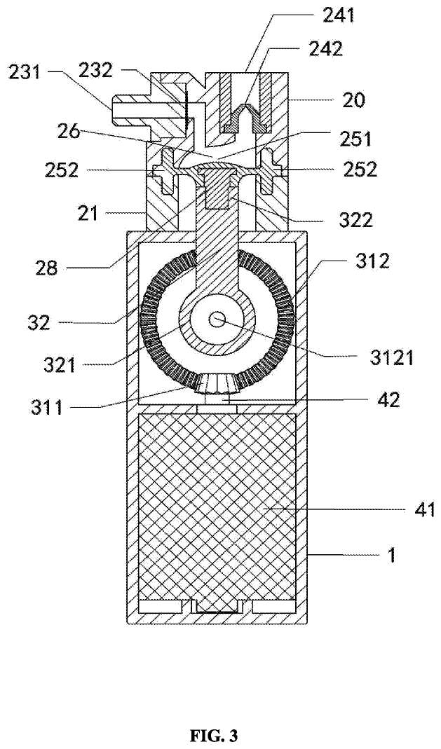

Referring to FIGS. 3-5, the elastic diaphragm 25 is hermetically connected with the pump body 20, the elastic diaphragm 25 comprises a deformation portion 251 and a connection portion 252, the connection portion 252 is a peripheral edge extending in an axial direction of the elastic diaphragm 25, and the peripheral edge is annular, a lower end face of the upper pump body 21 and/or an upper end face of the lower pump body 22 are provided with a recessed structure in which the peripheral edge is tightly crimped to prevent the liquid from penetrating from the water flow cavity into the driving assembly 4, which will causes damage to the motor and affects normal use of the water flosser.

The deformation portion 251 comprises a first deformation portion 2511 and a second deformation portion 2512. A thickness of the first deformation portion 2511 is greater than a thickness of the second deformation portion 2512, thereby reducing wear caused by the reciprocating motion of the connecting rod 32 and improving service life of the elastic diaphragm 25. A hardness of the first deformation portion 2511 is greater than a hardness of the second deformation portion 2512 so as to prevent the elastic diaphragm 25 from generating protrusion in the case of too fast motion of the water pump assembly 2, resulting in insufficient pumping or insufficient impact force. On the other hand, the second deformation portion 2512 is a shorter and thinner elastic material than the first deformation portion 2511, so that the transmission assembly 3 can more easily deform the elastic diaphragm and improve pumping and jetting efficiency of the water pump assembly 2, thereby improving user experience.

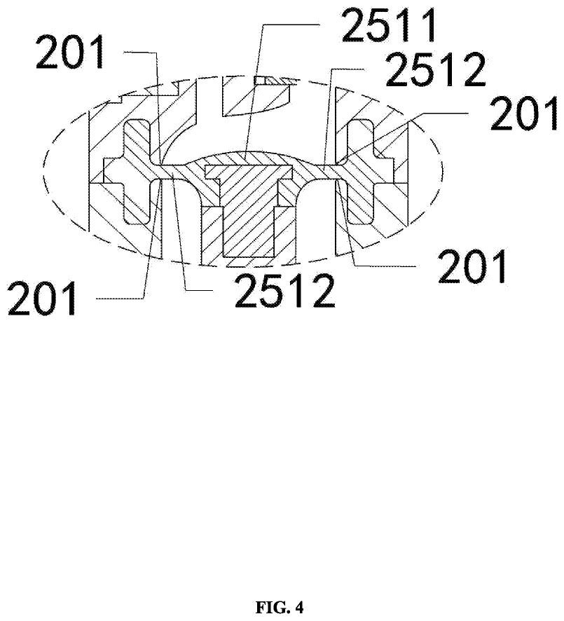

Referring to FIG. 4, the upper pump body 21 and the lower pump body 22 have a pump body end face chamfer 201, which reduces wear at a connection between the elastic diaphragm 25 and the pump body 20 during motion, improves service life of the elastic diaphragm 25, and prevents a connection edge of the elastic diaphragm 25 from breakage and prevents liquid from leaking out from the broken edge of the elastic diaphragm 25, because such breakage prevents formation of a sealed space inside the pump body 20 so that the water pump assembly 2 cannot perform normal pumping and jetting activities, and such leakage results in damage to an internal motor and affects normal use of the water flosser.

Referring to FIGS. 6-9, a first drainage channel 211 and a second drainage channel 212 are provided on the upper pump body 21, one end of the first drainage channel 211 is connected with the second deformation portion 2512 of the elastic diaphragm 25, the other end of the first drainage channel 211 is connected with one end of the inlet channel 261, and the first drainage channel 211 extends in the direction of the outlet channel 262; and one end of the second drainage channel 212 is connected with the inlet channel 261, the other end of the second drainage channel 212 is connected with one end of the outlet channel 262, and the second drainage channel 212 extends in the direction of the outlet channel 262.

When the water pump assembly 2 is in a jetting state, the liquid in the water flow cavity 26 flows in the direction of the first drainage channel 211 and the second drainage channel 212, converges towards the outlet channel 262, impacts the outlet valve sheet 242, flows into a nozzle line from the outlet 241 and then is jetted out from a nozzle. The first drainage channel 211 and the second drainage channel 212 guide the liquid in the water flow cavity 26 to converge towards the outlet channel 262 during decrease of a volume inside the water flow cavity 26, so as to reduce a reaction force of water pressure on the elastic diaphragm 25 during rapid reciprocating motion of the water pump assembly 2, and improve pumping and jetting capacity of the water pump assembly 2.

The inlet valve sheet 23 is provided with a limiting groove 233 thereon, and the limiting groove 233 limits an opening and closing angle of the inlet valve sheet 232, so as to prevent the inlet valve sheet 232 from being excessively deformed by the impact of high-speed and high-pressure water flow, resulting in deteriorated elastic recovery capacity thereof, so that in the process of reducing the volume of the water flow cavity 26 (the jetting process), the inlet valve sheet 232 fails to completely cover the inlet 231, so that sealing effect thereof is poor, resulting in that in the jetting process, air can enter the pump body cavity through a gap at the inlet 231, so that sufficient pressure cannot be formed in the pump body cavity, resulting in insufficient amount of the liquid jetted in a single jetting process.

Referring to FIGS. 1-3, the transmission assembly 3 comprises a gear transmission mechanism 31 and a connecting rod 32, the connecting rod 32 comprises a first fixing portion 321 and a second fixing portion 322, the first fixing portion 321 is connected to the gear transmission mechanism 31, the second fixing portion 322 is connected to the elastic diaphragm 25 through a connector 28, the gear transmission mechanism 31 is used for driving the connecting rod 32 to move, and when the gear rotation mechanism 31 rotates, the connecting rod 32 is driven to move; and the connecting rod 32 drives the elastic diaphragm 25 to repeatedly deform to cause a change in the pressure in the water flow cavity 26, thereby realizing the pumping and jetting process of the water flosser for flossing teeth.

The gear transmission mechanism 31 comprises a gear 311 and an eccentric gear 312, the eccentric gear 312 has a tooth space adapted to the gear 311, the gear 311 is in meshing rotation with the eccentric gear 312, the eccentric gear 312 further comprises an eccentric gear fixing shaft 3121, the eccentric gear fixing shaft 3121 is connected with the first fixing portion 321 of the connecting rod 32, the gear 311 is connected with a motor output shaft 42, the gear 311 converts rotary motion of the driving assembly 4 in a horizontal direction into the rotary motion in a vertical direction, and the eccentric gear 312 converts the rotary motion on the gear 311 into reciprocating motion, powering the motion of the connecting rod 32 and the elastic diaphragm 25.

During the reciprocating pumping and jetting motion of the water flosser pump body, piston motion of a conventional piston is replaced with the reciprocating motion of the elastic diaphragm 25, reducing energy loss due to friction. The volume of the water flow cavity 26 in the water pump assembly 2 is small, a distance from the inlet 231 to the water flow cavity 26 is short, and a first drainage channel 211 and a second drainage channel 212 are provided in the pump body 20. In the pumping and jetting operation in a single process, the drainage channel guides the liquid to converge to the outlet channel 262, so that the liquid in the water flow cavity is completely discharged, which decreases the reaction force of the water pressure on the elastic diaphragm 25, solves abnormal water inflow and outflow of the pump body due to accumulated air in the cavity of the water pump assembly 2 which cannot be removed under natural water inflow and outflow state of a conventional diaphragm pump, and improves flossing efficiency.

In an embodiment of the present invention, when the water pump assembly 2 is in a single pumping jetting process, the inlet 231 has a single intake volume less than or equal to a maximum intake containment volume of the water flow cavity 26, so as to ensure that the liquid in the water flow cavity 26 can be completely jetted out from the outlet 241, avoiding occurrence of liquid backflow or overflow, and avoiding generation of bubbles in the water flow cavity due to liquid convergence.

In an embodiment of the present invention, a connection between the inlet valve member 23 and the outlet valve member 24 and the upper pump body 21 is provided with a sealing ring 27 to prevent liquid leakage during the inlet or outlet process.

In the present embodiment, the outlet valve member 24 is directly connected with a water flosser nozzle valve member (not shown) to reduce water pressure loss and improve flossing efficiency.

In the present embodiment, the inlet valve sheet 232 and the outlet valve sheet 242 are one-way valve sheets, and a flow direction of the liquid through the valve sheets is a one-way. In particular, the outlet valve sheet is a duckbill valve sheet, which is easy to assemble, and can play the role of isolating the liquid.

In the present embodiment, the driving assembly 4 is a known micro-motor 41 and the micro-motor also comprises a motor output shaft 42, which is not limited in the present invention.

In the present embodiment, the number of teeth of the gear 311 and the eccentric gear 312 is set as needed, which is not limited in the present invention.

A connector 28 is connected to the first deformation portion 251 of the elastic diaphragm, and a portion of the connector 28 is located inside the first deformation portion 2511, another portion thereof is located outside the first deformation portion 2511, and the portion of the connector 28 located outside the first deformation portion 2511 is used for connecting with the connecting rod 32.

For example, the connector 28 may be a screw by which the elastic diaphragm 25 is connected with the connecting rod 32. Specifically, a screw is fixedly connected to a center of the first deformation portion 2511 of the elastic diaphragm 25, a nut is fixedly connected to the screw of the first deformation portion 2511 on the second fixing portion 322 of the connecting rod, and the first deformation portion 2511 is bonded to the nut by means of vulcanization.

In the present embodiment, the elastic diaphragm 25 is integrally formed, and the elastic diaphragm 25 is made of an elastic material such as rubber or silica gel. Compared with a piston structure, the diaphragm can have a better waterproofing effect, and the diaphragm does not generate friction with an inner wall of the water flow cavity of the water pump assembly during the movement, so that frictional damage can be avoided and the energy loss can be reduced to ensure driving stability.

In the present embodiment, the outlet 241 is oriented parallel to the motor output shaft 42, which allows for a more compact assembly structure and thus a more compact pump structure.

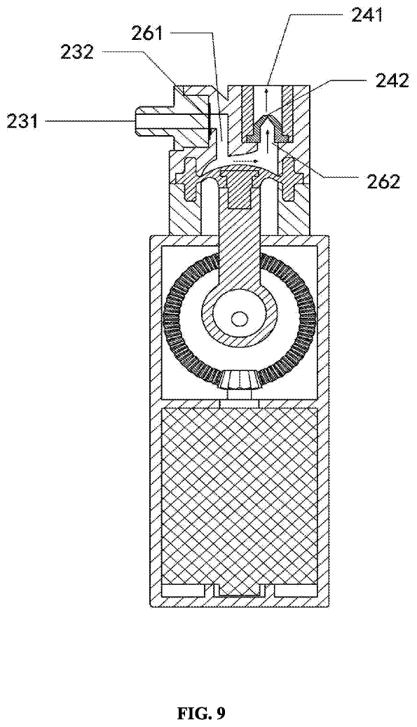

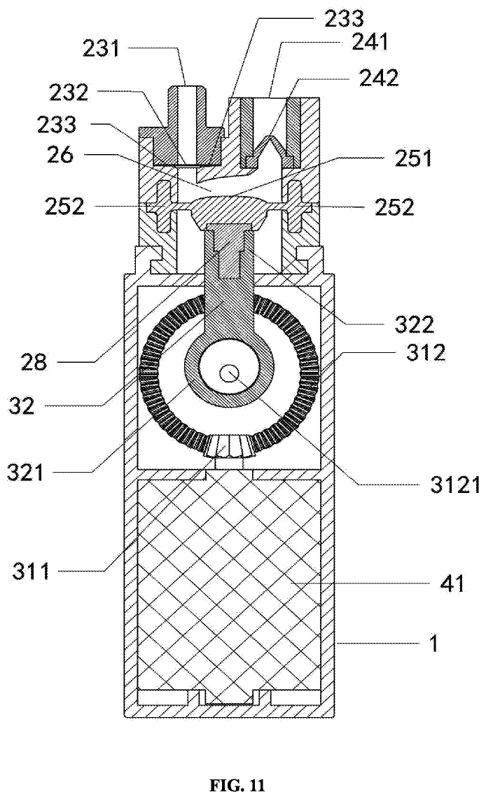

In an embodiment of the present invention, an assembly position relationship between the inlet valve member 23 and the outlet valve member 24 is vertical assembly, and correspondingly, a water flow direction of the inlet 231 and the outlet 241 is in a vertical relationship, as shown in FIG. 11. In another embodiment of the present invention, the assembly position relationship between the inlet valve member 23 and the outlet valve member 24 is a parallel assembly. Referring to FIG. 9, the water flow direction of the inlet 231 and the outlet 241 is in a parallel relationship, and the structural design can be adapted to more water flosser structures, and can be specifically arranged according to needs, and the present invention does not limit thereto.

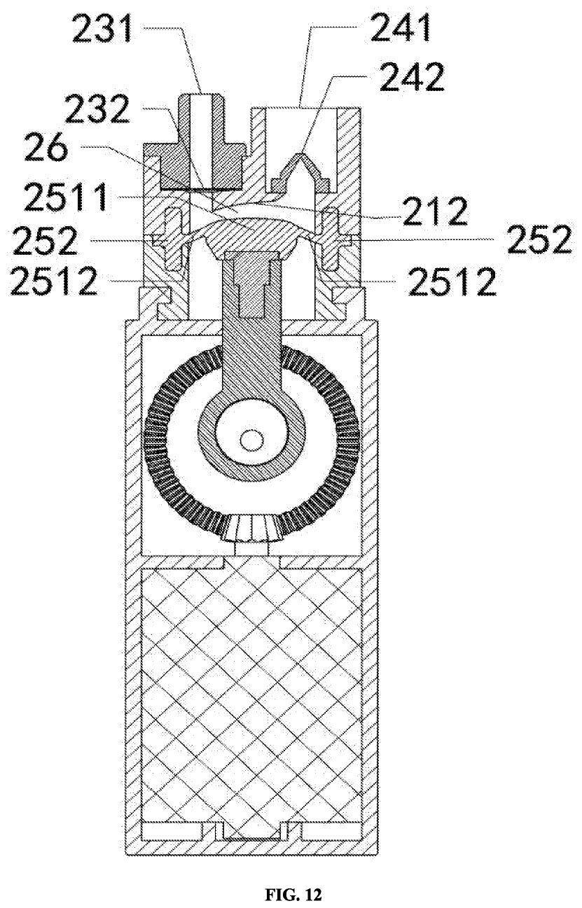

Referring to FIG. 12, only the second drainage channel 212 is provided on the upper pump body 21, one end of the second drainage channel 212 is connected with the inlet channel 261, and the other end is connected with the outlet channel 262, and the second drainage channel 212 extends in the direction of the outlet channel 262. When the water pump assembly 2 is in the jetting state, the liquid in the water flow cavity 26 flows in the direction of the second drainage channel 212, converges towards the outlet channel 262, impacts the outlet valve sheet 242, flows into the nozzle line from the outlet 241 and then is jetted out from the nozzle. The second drainage channel 212 guides the liquid in the water flow cavity 26 to converge towards the outlet channel 262 during the decrease of the volume inside the water flow cavity 26, so as to reduce the reaction force of the water pressure on the elastic diaphragm 25 during the rapid reciprocating motion of the water pump assembly 2, and improve the pumping and jetting capacity of the water pump assembly 2.

The water flosser of the present invention is provided with the above-mentioned water flosser pump body, the amount of liquid jetted out from the water flosser pump body is uniform, and the jetting is smooth, thus better cleaning the oral cavity, and providing better user experience.

Although the present invention has been described with reference to the foregoing preferred embodiments, it should be noted that those skilled in the art can make several improvements and modifications without departing from the principles of the present invention, and such modifications and modifications shall be construed to fall into the scope of the present invention.

What is claimed is:

1. A water flosser pump body structure, comprising:
a housing;
a water pump assembly, the water pump assembly comprising a pump body, an inlet valve member, an outlet valve member and an elastic diaphragm, the inlet valve member being provided with an inlet and an inlet valve sheet thereon, the outlet valve member being provided with an outlet and an outlet valve sheet thereon, a water flow cavity being provided inside the pump body, the inlet valve sheet and the water flow cavity forming an inlet channel, and the outlet valve sheet and the water flow cavity forming an outlet channel;
a transmission assembly; and
a driving assembly; and
the transmission assembly rotating to drive the elastic diaphragm to repeatedly deform to cause a change in pressure in the water flow cavity, thereby realizing a pumping and jetting process of a water flosser for flossing teeth.

2. The water flosser pump body structure according to claim 1, wherein the elastic diaphragm is hermetically connected with the pump body, the pump body comprises an upper pump body and a lower pump body, both ends of the pump body connected with the elastic diaphragm have a pump body end face chamfer, and the upper pump body has a first drainage channel and a second drainage channel in the direction of the outlet channel.

3. The water flosser pump body structure according to claim 2, wherein the elastic diaphragm comprises a deformation portion and a connection portion, the connection portion is used for connected and fixed with the pump body, and the deformation portion comprises a first deformation portion and a second deformation portion.

4. The water flosser pump body structure according to claim 3, wherein a thickness of the first deformation portion is greater than a thickness of the second deformation portion, a length of the second deformation portion is less than a length of the first deformation portion, and a hardness of the first deformation portion is greater than a hardness of the second deformation portion; and
the elastic diaphragm is integrally formed, and the elastic diaphragm is made of an elastic material such as rubber and silica gel.

5. The water flosser pump body structure according to claim 1, wherein the transmission assembly comprises a gear transmission mechanism and a connecting rod, and the gear transmission mechanism is connected with the connecting rod for driving the connecting rod to move.

6. The water flosser pump body structure according to claim 5, wherein the connecting rod is connected with the elastic diaphragm through a connector.

7. The water flosser pump body structure according to claim 5, wherein the gear transmission mechanism comprises a gear and an eccentric gear, the gear is in meshing rotation with the eccentric gear, the eccentric gear further comprises an eccentric gear fixing shaft, and the eccentric gear fixing shaft is connected with the connecting rod.

8. The water flosser pump body structure according to claim 5, wherein when the gear transmission mechanism pulls the elastic diaphragm from inside to outside, the deformation portion of the elastic diaphragm is deformed towards the outside of the water flow cavity, so that a volume inside the water flow cavity increases, and external water can enter the water flow cavity from the inlet through the inlet valve sheet; and
when the gear transmission mechanism pushes the elastic diaphragm from outside to inside, the elastic diaphragm is deformed towards the inside of the water flow cavity, so that the volume inside the water flow cavity decreases, and water in the water flow cavity can be jetted out from the outlet through the outlet valve sheet.

9. The water flosser pump body structure according to claim 8, wherein the inlet has a single intake volume less than or equal to a maximum intake containment volume of the water flow cavity, and the water flow cavity is used for containing a tooth wash liquid.

10. The water flosser pump body structure according to claim 8, wherein the inlet valve sheet and the outlet valve sheet are one-way valve sheets, and a flow direction of the liquid through the valve sheets is one-way.

11. The water flosser pump body structure according to claim 1, wherein the driving mechanism comprises a micro-motor, and the micro-motor has a motor output shaft thereon; and
the upper pump body is connected with the inlet valve member and the outlet valve member, and a sealing ring is provided at a connection between the inlet valve member or the outlet valve member and the upper pump body.

12. The water flosser pump body structure according to claim 11, wherein the inlet valve member is provided with a limiting groove thereon, and the limiting groove limits an opening and closing angle of the inlet valve sheet.

13. A water flosser pump body structure, comprising a water pump assembly, wherein the water pump assembly comprises a pump body and an elastic diaphragm, the elastic diaphragm is hermetically connected with the pump body, both ends of the pump body connected with the elastic diaphragm have a pump body end face chamfer, the elastic diaphragm comprises a deformation portion and a connection portion, the connection portion is a peripheral edge extending in an axial direction of the elastic diaphragm, and the peripheral edge is annular; and a lower end face of the upper pump body and/or an upper end face of the lower pump body is provided with a recessed structure, and the peripheral edge is tightly crimped in the recessed structure.

14. The water flosser pump body structure according to claim 13, wherein the deformation portion comprises a first deformation portion and a second deformation portion, a thickness of the first deformation portion is greater than a thickness of the second deformation portion, a length of the second deformation portion is less than a length of the first deformation portion, and a hardness of the first deformation portion is greater than a hardness of the second deformation portion.

15. The water flosser pump body structure according to claim 13, wherein the water pump assembly further comprises an inlet valve member and an outlet valve member, and the inlet valve member and the outlet valve member have an inlet valve sheet and an outlet valve sheet respectively mounted thereon; and
a sealing ring is provided at a connection between the inlet valve member or the outlet valve member and the pump body.

16. The water flosser pump body structure according to claim 15, wherein the inlet valve member is provided with a limiting groove thereon, and the limiting groove limits an opening and closing angle of the inlet valve sheet.

17. The water flosser pump body structure according to claim 13, wherein the water flosser pump body structure further comprises a transmission assembly and a driving assembly, the transmission assembly comprises a gear transmission mechanism and a connecting rod, the gear transmission mechanism is connected with the connecting rod, and the gear transmission mechanism is used for driving the connecting rod to move; and the driving assembly is connected with the gear transmission mechanism and provides power for the gear transmission mechanism.

18. The water flosser pump body structure according to claim 17, wherein the connecting rod is connected with the elastic diaphragm through a connector, and the connecting rod is used for driving the elastic diaphragm to repeatedly deform so as to cause a change in pressure in the pump body, thereby achieving the function of pumping and jetting.

19. The water flosser pump body structure according to claim 18, wherein the pump body is provided with a water flow cavity therein, when the gear transmission mechanism pulls the elastic diaphragm from inside to outside, the deformation portion of the elastic diaphragm is deformed towards the outside of the water flow cavity, so that a volume inside the water flow cavity increases, and external water can enter the water flow cavity from the inlet through the inlet valve sheet; and when the gear transmission mechanism pushes the elastic diaphragm from outside to inside, the elastic diaphragm is deformed towards the inside of the water flow cavity, so that the volume inside the water flow cavity decreases, and water in the water flow cavity can be jetted out from the outlet through the outlet valve sheet; and
the elastic diaphragm is integrally formed, and the elastic diaphragm is made of an elastic material such as rubber and silica gel.

20. A water flosser, comprising the water flosser pump body structure according to claim 1.
